(19) United States
(12) Patent Application Publication
(10) Pub. No.: US 2026/0367248 A1
(43) Pub. Date: Nov. 19, 2026

(54) STAGGERED ULTRASONIC TRANSDUCER

(71) Applicant: QISDA CORPORATION, Taoyuan City (TW)

(72) Inventor: FU-SHENG JIANG, Taoyuan City (TW)

(21) Appl. No.: 19/668,820

(22) Filed: May 6, 2026

(30) Foreign Application Priority Data
May 13, 2025 (TW) 114117783

(51) Int. Cl. G01S 15/89; G01S 7/521

(52) U.S. Cl. CPC G01S 15/8927; G01S 7/521

(57) ABSTRACT

A staggered ultrasonic transducer includes an ultrasonic generation module. The ultrasonic generation module includes a first ultrasonic element array and two second ultrasonic element arrays. The first ultrasonic element array includes a plurality of first ultrasonic elements. The first ultrasonic elements are arranged along a first direction with a first pitch. The two second ultrasonic element arrays are aligned with each other and parallel to the first ultrasonic element array. The first ultrasonic element array is disposed between the two second ultrasonic element arrays. Each of the second ultrasonic element arrays includes a plurality of second ultrasonic elements. The second ultrasonic elements are arranged along the first direction. In the first direction, the two second ultrasonic element arrays are offset relative to the first ultrasonic element array by a first predetermined distance. The first predetermined distance is equal to 1/3 to 3/4 of the first pitch.

### CROSS-REFERENCE TO RELATED PATENT APPLICATION

This application claims the benefit of priority to Taiwan Patent Application No. 114117783, filed on May 13, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an ultrasonic transducer, and more particularly to a staggered ultrasonic transducer.

### BACKGROUND OF THE DISCLOSURE

Existing ultrasonic transducers can be classified into different types, such as 1D, 1.25D, and 1.5D, according to different array designs. In a 1D ultrasonic transducer, the internal ultrasonic array elements are arranged linearly along a single direction, for example, along an X-axis. The 1D ultrasonic transducer enables electronic focusing on a main scanning plane (e.g., an X–Y plane), but lacks sufficient focusing capability in an elevation direction (e.g., along a Z-axis). In contrast, the 1.25D or 1.5D ultrasonic transducers have a greater equivalent width in the elevation direction (i.e., a short-axis direction), thereby allowing the electronic focusing capability in the elevation direction to be improved.

However, increasing the width of the ultrasonic transducer in the elevation direction also means that the short-axis width of the ultrasonic transducer becomes larger. When the short-axis width of the ultrasonic transducer exceeds one-half wavelength of the operating frequency of the ultrasonic transducer, the sidelobe effect becomes more aggravated to generate artifact, thereby adversely affecting imaging resolution.

### SUMMARY OF THE DISCLOSURE

In response to the above-referenced technical inadequacies, the present disclosure provides a staggered ultrasonic transducer that is capable of improving imaging resolution while reducing the sidelobe effect and minimizing artifact generation.

In order to solve the above-mentioned problems, one of the technical aspects adopted by the present disclosure is to provide a staggered ultrasonic transducer. The staggered ultrasonic transducer includes a first ultrasonic element array and two second ultrasonic element arrays. The first ultrasonic element array includes a plurality of first ultrasonic elements. The first ultrasonic elements are arranged along a first direction with a first pitch. The two second ultrasonic element arrays are aligned with each other and parallel to the first ultrasonic element array. The first ultrasonic element array is disposed between the two second ultrasonic element arrays. Each of the second ultrasonic element arrays includes a plurality of second ultrasonic elements. The second ultrasonic elements are arranged along the first direction. In the first direction, each of the two second ultrasonic element arrays is offset relative to the first ultrasonic element array by a first predetermined distance. The first predetermined distance is equal to 1/3 to 3/4 of the first pitch.

Therefore, in the staggered ultrasonic transducer provided by the present disclosure, through offsetting the two second ultrasonic element arrays in a first direction relative to the first ultrasonic element array by a first predetermined distance that is equal to 1/3 to 3/4 of a first pitch, the overall width of the ultrasonic element arrangement along the short-axis direction can be effectively reduced. As a result of the staggered configuration, the energy of the side lobes generated by the staggered ultrasonic transducer no longer accumulates along a same straight line, thereby effectively reducing sidelobe intensity, decreasing artifact generation, and improving imaging resolution. In other words, the staggered ultrasonic transducer provided by the present disclosure simultaneously enhances focusing performance in the elevation direction and suppresses sidelobe effects, thereby significantly improving ultrasonic imaging quality.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a staggered ultrasonic transducer according to the present disclosure;

FIG. 2 is a schematic cross-sectional view of an ultrasonic generation module according to a first embodiment of the present disclosure;

FIG. 3 is a schematic enlarged view of part III of FIG. 2;

FIG. 4 is a schematic cross-sectional view of the staggered ultrasonic transducer according to the first embodiment of the present disclosure;

FIG. 5 is a schematic enlarged view of part IV of FIG. 4;

FIG. 6 is a functional block diagram of the staggered ultrasonic transducer according to the present disclosure;

FIG. 7 is a schematic cross-sectional view of an ultrasonic generation module according to a second embodiment of the present disclosure;

FIG. 8 is a schematic enlarged view of part VIII of FIG. 7;

FIG. 9 is a schematic cross-sectional view of an ultrasonic generation module according to a third embodiment of the present disclosure;

FIG. 10 is a schematic enlarged view of part X of FIG. 9;

FIG. 11 is a schematic cross-sectional view of an ultrasonic generation module according to a fourth embodiment of the present disclosure; and

FIG. 12 is a schematic enlarged view of part XII of FIG. 11.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

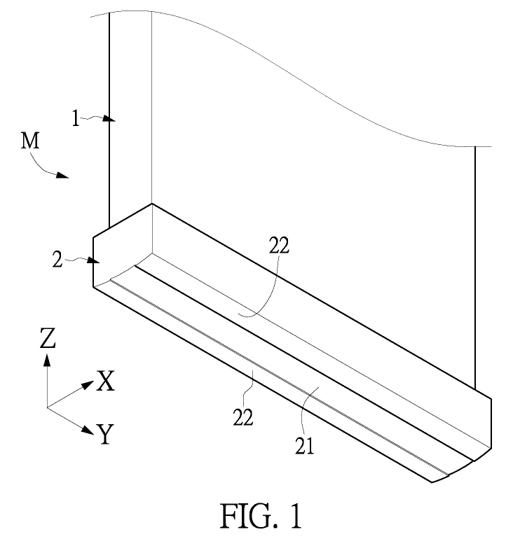

Reference is made to FIG. 1. FIG. 1 is a schematic view of a staggered ultrasonic transducer according to the present disclosure. The present disclosure provides a staggered ultrasonic transducer M, which includes an ultrasonic generation module 1. The ultrasonic generation module 1 can be made of a piezoelectric material (e.g., a PZT piezoelectric ceramic material). In addition, the staggered ultrasonic transducer M may optionally include an acoustic lens layer 2. The acoustic lens layer 2 is disposed on one side of the ultrasonic generation module 1. Moreover, the staggered ultrasonic transducer M may further include a backing material layer and a matching layer (not shown in the figures). The backing material layer is disposed on one side of the ultrasonic generation module 1, and the matching layer is disposed on another side of the ultrasonic generation module 1 and located between the ultrasonic generation module 1 and the acoustic lens layer 2.

In the following first to fourth embodiments, different implementations of the ultrasonic generation module 1 will be described. For convenience of explanation, the ultrasonic generation module 1 in FIG. 1 can further be distinguished as ultrasonic generation modules 1A, 1B, 1C, and 1D in the first to fourth embodiments, respectively, and all of the ultrasonic generation modules 1A, 1B, 1C, and 1D can operate in conjunction with the acoustic lens layer 2, and will not be reiterated herein.

### First Embodiment

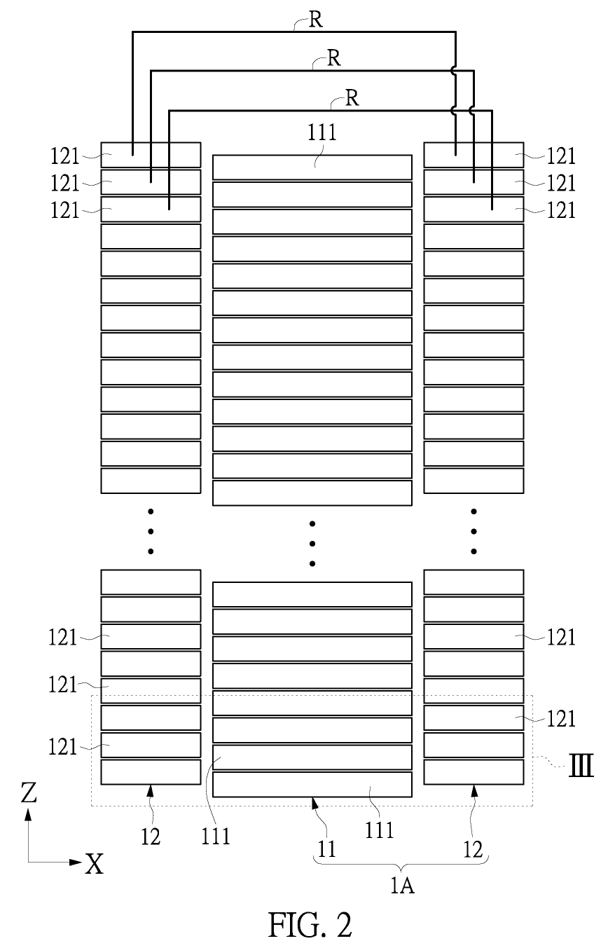

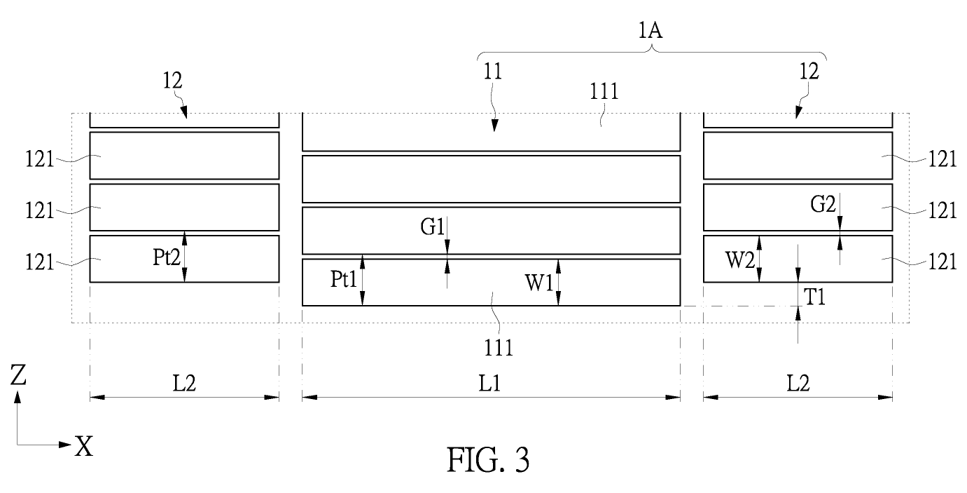

Reference is made to FIGS. 2 and 3. FIG. 2 is a schematic cross-sectional view of an ultrasonic generation module according to a first embodiment of the present disclosure. FIG. 3 is a schematic enlarged view of part III of FIG. 2. In the first embodiment, the staggered ultrasonic transducer M includes an ultrasonic generation module 1A. The ultrasonic generation module 1A includes a first ultrasonic element array 11 and two second ultrasonic element arrays 12. The two second ultrasonic element arrays 12 are located on two sides of the first ultrasonic element array 11, respectively. That is, the first ultrasonic element array 11 is disposed between the two second ultrasonic element arrays 12.

The first ultrasonic element array 11 includes a plurality of first ultrasonic elements 111 arranged along a first direction (i.e., a Z-axis direction). Each of the second ultrasonic element arrays 12 includes a plurality of second ultrasonic elements 121 arranged along the first direction. Any two adjacent first ultrasonic elements 111 of the first ultrasonic element array 11 are spaced apart by a first gap G1, and any two adjacent second ultrasonic elements 121 of each of the second ultrasonic element arrays 12 are spaced apart by a second gap G2. The first gap G1 and the second gap G2 can be formed by dicing or a photomask exposure process, and the present disclosure is not limited thereto. The first gap G1 and the second gap G2 should be minimized as much as possible to reduce leakage of ultrasonic waves and energy loss in non-working areas.

Furthermore, the plurality of first ultrasonic elements 111 are arranged with a first pitch Pt1, and the plurality of second ultrasonic elements 121 are arranged with a second pitch Pt2. The term “pitch” refers to a sum of a width of one ultrasonic element and a gap between two adjacent ultrasonic elements. Therefore, as shown in FIG. 3, the first pitch Pt1 is the sum of the width W1 of a first ultrasonic element 111 and the first gap G1, and the second pitch Pt2 is the sum of the width W2 of a second ultrasonic element 121 and the second gap G2.

Preferably, the first gap G1 and the second gap G2 are each less than 25% of the first pitch Pt1. For example, if the first pitch Pt1 is 0.1 mm, the first gap G1 and the second gap G2 ranges from 5 µm to 15 µm.

The two second ultrasonic element arrays 12 and the first ultrasonic element array 11 are arranged in a staggered configuration. Specifically, in the first direction, the two second ultrasonic element arrays 12 are offset relative to the first ultrasonic element array 11 by a first predetermined distance T1, and the first predetermined distance T1 is equal to 1/3 to 3/4 times the first pitch Pt1. Preferably, the first predetermined distance T1 is 1/2 times the first pitch Pt1.

As shown in FIG. 3, each of the first ultrasonic elements 111 extends along a second direction (i.e., an X-axis direction) that is perpendicular to the first direction and has a first length L1. Each of the second ultrasonic elements 121 also extends along the second direction and has a second length L2. Although the first length L1 is greater than the second length L2, the present disclosure is not limited thereto. In other embodiments, the first length L1 may be equal to or less than the second length L2. Preferably, the first length L1 of each of the first ultrasonic elements 111 is equal to 40% to 70% of a total length of the ultrasonic generation module 1A in the second direction. Referring to FIG. 1, the second direction corresponds to a short-axis direction of the staggered ultrasonic transducer M, and the short-axis direction represents an elevation direction when scanning a target (not shown in the figures).

For example, in the first embodiment, the first length L1 is twice the second length L2. Therefore, the first length L1 of the first ultrasonic element 111 is equal to 50% of the total length of the ultrasonic generation module 1A in the second direction, and the second length L2 of each of the second ultrasonic elements 121 is equal to 25% of the total length of the ultrasonic generation module 1A in the second direction. However, the present disclosure is not limited thereto. In other embodiments, the first length L1 of the first ultrasonic element 111 can be equal to 70% of the total length of the ultrasonic generation module 1A in the second direction, and the second length L2 of each second ultrasonic element 121 can be equal to 15% of the total length of the ultrasonic generation module 1A in the second direction.

The imaging quality can be optimized by designing the ultrasonic element arrays within the ultrasonic generation module 1A in a staggered configuration. Specifically, in the first direction, the two second ultrasonic element arrays 12 are offset relative to the first ultrasonic element array 11 by the first predetermined distance T1, so that the first ultrasonic element 111 and the two second ultrasonic elements 121 arranged along the second direction are non-collinear (i.e., not on the same axis). This structural configuration can effectively reduce an equivalent width of the ultrasonic generation module 1A in the short-axis direction. Through the staggered design, when the ultrasonic generation module 1A emits an ultrasonic beam, the sidelobe energy that may originally concentrate and overlap along a specific axial direction can be dispersed, reducing the accumulation effect of the sidelobe energy, effectively lowering sidelobe intensity in the near field, thereby suppressing artifact generation and optimizing imaging quality.

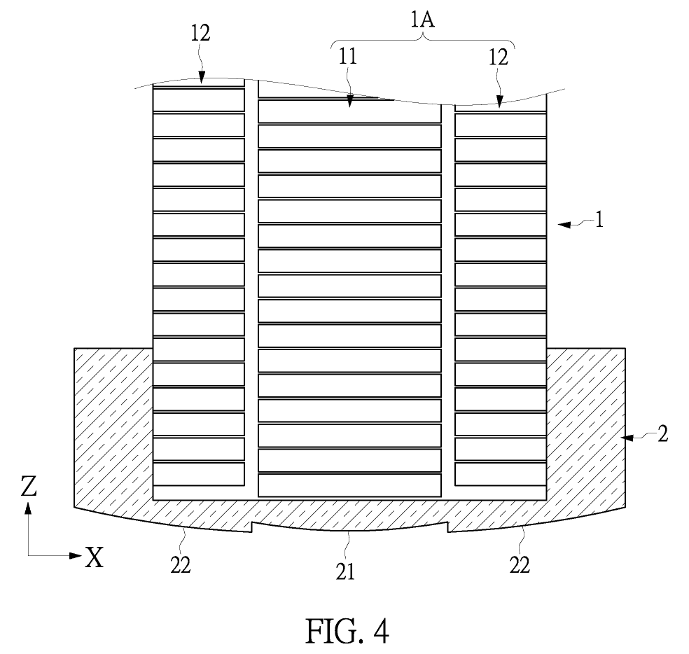

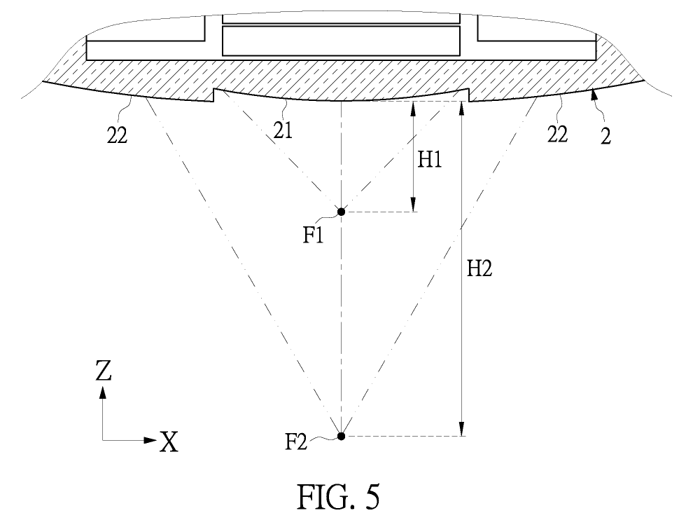

Reference is made to FIGS. 4 and 5. FIG. 4 is a schematic cross-sectional view of the staggered ultrasonic transducer according to the first embodiment of the present disclosure, and FIG. 5 is a schematic enlarged view of part IV of FIG. 4. A contour shape of a lens surface of the acoustic lens layer 2 is similar to that of a Fresnel lens. The lens surface of the acoustic lens layer 2 includes a first lens surface 21 and two second lens surfaces 22, and the first lens surface 21 is disposed between the two second lens surfaces 22. Specifically, the contour shape of the first lens surface 21 is arc-shaped, and the contour shape of the second lens surfaces 22 is jagged. The two second lens surfaces 22 are symmetrically disposed on two sides of the first lens surface 21. When the ultrasonic generation module 1A operates in conjunction with the acoustic lens layer 2, the first lens surface 21 corresponds to the first ultrasonic element array 11, and the two second lens surfaces 22 correspond to the two second ultrasonic element arrays 12, respectively. Since the two second ultrasonic element arrays 12 in the ultrasonic generation module 1A are symmetrically arranged, the ultrasonic generation module 1A that operates in conjunction with the acoustic lens layer 2 can further optimize and reduce sidelobe intensity to suppress artifact generation.

By adjusting the surface geometry of the acoustic lens layer 2 in different regions, the staggered ultrasonic transducer M of the present disclosure can change its local curvature distribution to form two different focal positions: a near-field focus F1 of the first lens surface 21 and two far-field focuses F2 of the two second lens surfaces 22. The near-field focus F1 has a first focal length H1, and the far-field focus F2 has a second focal length H2. The second focal length H2 is greater than the first focal length H1. Specifically, by controlling the curvature at the front and side edges of the acoustic lens layer 2, a portion of the ultrasonic energy is refracted and phase-modulated to focus at the near-field focus F1 close to the probe side, while another portion of the ultrasonic energy is guided to focus at the deeper far-field focus F2. This dual-focus design can simultaneously cover shallow and deep target regions in a single emission, thereby satisfying imaging requirements for both resolution and penetration depth.

Because the acoustic lens layer 2 has a non-uniform curvature distribution, the resulting phase interference and energy deflection effects effectively modify the spatial radiation pattern of the ultrasonic beam. When the ultrasonic beam passes through different curvature regions, its wavefront produces a specific deflection, so that the sidelobe energy that may have been generated in the near-field region is directed to the far-field region, thereby improving artifacts in near-field images and enhancing edge clarity and image contrast in close-range imaging.

Furthermore, the curvature design of the acoustic lens layer 2 corresponding to the far-field focusing region can concentrate the ultrasonic energy to effectively penetrate highly attenuating tissues, thereby increasing the signal strength and resolution of deep structures, which is particularly advantageous for scanning deep organs (e.g., abdominal and pelvic regions), and can significantly improve deep imaging regarding penetration capability and detail resolution in conventional single-focus designs.

The staggered ultrasonic transducer M can achieve ultrasonic focusing and imaging by combining the ultrasonic generation module 1A with the acoustic lens layer 2 having dual curvature. Alternatively, the staggered ultrasonic transducer M can also achieve ultrasonic focusing and imaging by electronic focusing using the ultrasonic generation module 1A without the acoustic lens layer 2. The electronic focusing mode means that the first ultrasonic element array 11 and the second ultrasonic element array 12 in the ultrasonic generation module 1A are driven separately according to a predetermined time delay through independent control, so that the ultrasonic beams emitted by these ultrasonic element arrays interfere with each other and focus in a specific spatial region. Compared with fixed-focus imaging using the acoustic lens layer 2, this electronic focusing is adjustable and can dynamically change the focal position according to different scanning depths or imaging requirements, thereby improving the flexibility and resolution of ultrasonic imaging.

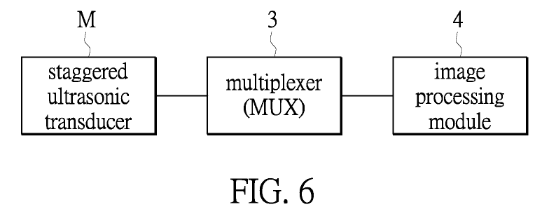

In continuation of the above, exemplary descriptions of the electronic focusing mode are provided below. As shown in FIGS. 2 and 6, FIG. 6 is a functional block diagram of the staggered ultrasonic transducer according to the present disclosure. In the two second ultrasonic element arrays 12, any two second ultrasonic elements 121 aligned with each other can be electrically connected in series through a wire R. The two second ultrasonic elements 121 that are connected in series can operate synchronously. In other words, the two second ultrasonic elements 121 emit and/or receive ultrasonic signals simultaneously and can be regarded as a single element during operation. The staggered ultrasonic transducer M is electrically connected to a multiplexer (MUX) 3 and an image processing module 4. The multiplexer 3 can selectively activate different elements and switch to transmit and receive modes according to predetermined timing to implement the scanning strategy. The image processing module 4 is configured to receive and process echo signals returned by the staggered ultrasonic transducer M to generate ultrasonic images. For example, the image processing module 4 can include, but is not limited to, a signal amplifier, a digital beam former, and an image processor.

For example, the staggered ultrasonic transducer M is a 64-channel system including 128 physical elements. The first ultrasonic element array 11 includes 64 independent elements, which are sequentially numbered 1 to 64 along a positive X-axis direction. Each of the two second ultrasonic element arrays 12 includes 64 second ultrasonic elements 121 that are aligned and series-connected, which are sequentially numbered 65 to 128 (the two corresponding elements are considered to be a same array element and have the same number).

When the system starts up, the multiplexer 3 performs timing-logic control to switch the first ultrasonic element array 11 to a transmit mode, and adjusts the transmit delay of each element to perform focusing control based on the focal position pre-computed by the image processing module 4. Then, the first ultrasonic element array 11 simultaneously transmits a base-frequency ultrasonic wave (e.g., 6 MHz). The base-frequency wave is transmitted to a surface of an object and is reflected. Thereafter, the multiplexer 3 switches the first ultrasonic element array 11 to a receive mode according to the timing sequence, and simultaneously switches the two second ultrasonic element arrays 12 to the receive mode. The reflected wave from the object is received by three arrays mentioned above. After front-end analog-to-digital conversion and signal amplification, they are delivered to the image processing module 4 for beamforming, timing comparison, and image reconstruction to generate a first ultrasonic image.

In continuation of the foregoing operation, the multiplexer 3 switches the first ultrasonic element array 11 to a transmit mode again based on the timing control, adjusts the transmission delay time of each element according to the position of the focus point pre-calculated by the image processing module 4, and drives the array to transmit a frequency-doubled ultrasonic wave (e.g., 12 MHz). After reflection from the object, the frequency-doubled ultrasonic wave is received by the first ultrasonic element array 11 and the two second ultrasonic element arrays 12, which have been switched to the receive mode. The obtained frequency-doubled ultrasonic signals are processed through the same signal chain and delivered to the image processing module 4 to generate a second, higher-frequency ultrasonic image. Finally, the image processing module 4 can combine the two images to produce a composite ultrasonic image with higher resolution and improved artifact suppression.

In another embodiment, for example, the staggered ultrasonic transducer M is a 128-channel system including 128 physical elements, the system is configured to achieve simultaneous focusing and reception of multi-frequency ultrasonic waves without requiring the multiplexer 3 for channel switching. As shown in FIG. 2, the first ultrasonic element array 11 includes 64 independent elements arranged along the positive X-axis direction and labeled in sequence with odd numbers (e.g., 1, 3, 5, …, 127). In the two second ultrasonic element arrays 12, the second ultrasonic elements 121 that are aligned and series-connected also includes 64 independent elements and are labeled in sequence with even numbers (e.g., 2, 4, 6, …, 128), so that the 128 sequentially numbered elements in the overall system form a staggered configuration.

In the transmit phase, the odd-numbered elements (i.e., the first ultrasonic element array 11) can be set to transmit a base-frequency ultrasonic wave (e.g., 6 MHz), while the even-numbered elements (i.e., the second ultrasonic element arrays 12) can be set to transmit a frequency-doubled ultrasonic wave (e.g., 12 MHz) either synchronously or with a predetermined delay time. By computing distance differences and timing delays from each element to the target focal point, accurate focusing of all 128 elements at the same focal location can be achieved while simultaneously providing multi-frequency characteristics that complement penetration and resolution. It should be noted that, depending on application requirements, the sources of the base-frequency and the frequency-doubled signals can be swapped with each other (i.e., the odd-numbered elements transmit the frequency-doubled ultrasonic wave and the even-numbered elements transmit the base frequency ultrasonic wave).

In the receive phase, the system can enable all 128 elements to receive ultrasonic signals concurrently, covering both the base-frequency and frequency-doubled signals. After front-end signal conditioning and digital conversion, all received data are delivered to the image processing module 4 for frequency separation, beamforming, and image fusion, ultimately producing a composite ultrasonic image with high resolution and enhanced artifact suppression.

### Second Embodiment

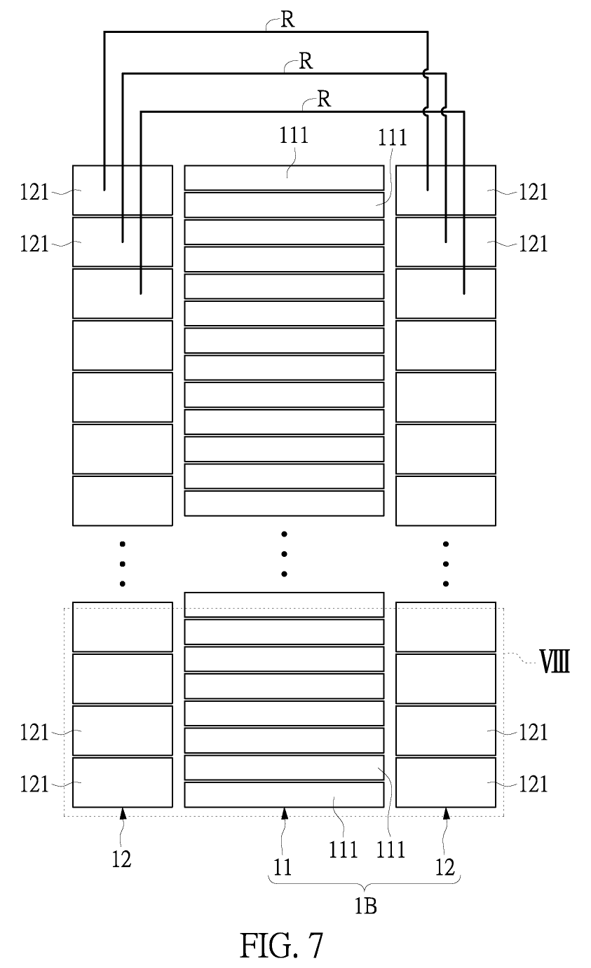

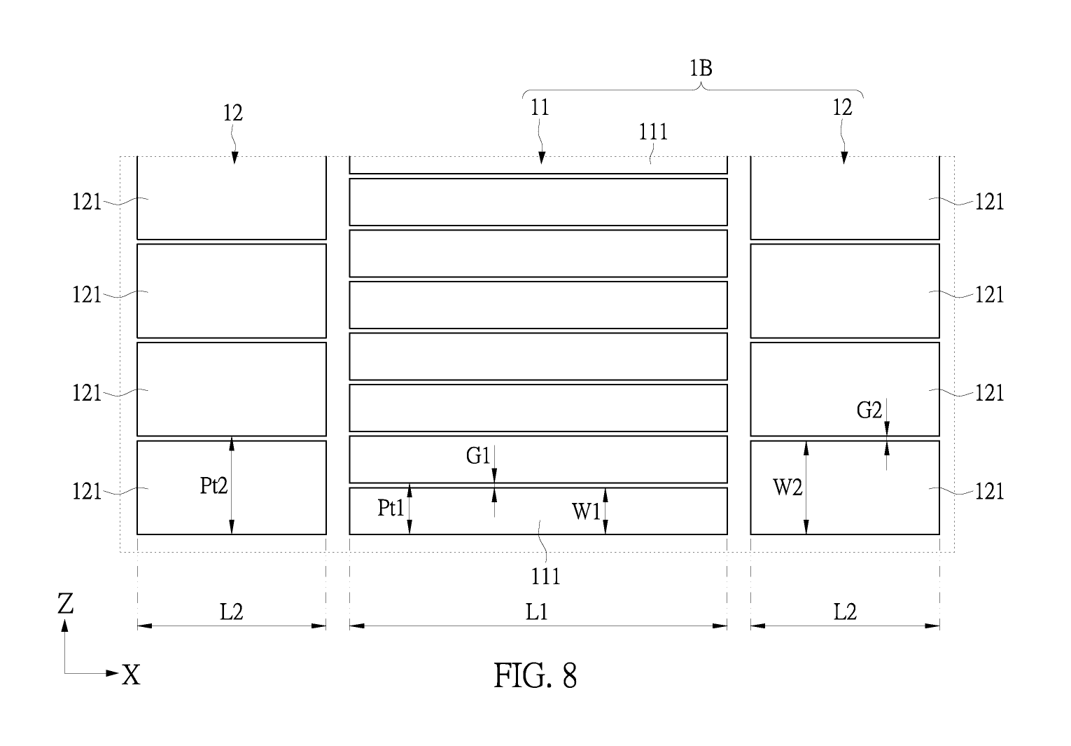

Reference is made to FIGS. 7 and 8. FIG. 7 is a schematic cross-sectional view of an ultrasonic generation module according to a second embodiment of the present disclosure, and FIG. 8 is a schematic enlarged view of part VIII of FIG. 7. In the second embodiment, the staggered ultrasonic transducer M includes an ultrasonic generation module 1B. The ultrasonic generation module 1B includes a first ultrasonic element array 11 and two second ultrasonic element arrays 12. The difference between the ultrasonic generation module 1B of the second embodiment and the ultrasonic generation module 1A of the first embodiment lies in that, in the ultrasonic generation module 1B, the second pitch Pt2 of the second ultrasonic element arrays 12 is greater than the first pitch Pt1 of the first ultrasonic element array 11. More specifically, the second pitch Pt2 is twice the distance of the first pitch Pt1.

It should be noted that, in the second embodiment, the leading edges of the two second ultrasonic element arrays 12 are aligned with the leading edge of the first ultrasonic element array 11. However, since the second pitch Pt2 of the second ultrasonic element arrays 12 is set to twice the distance of the first pitch Pt1 of the first ultrasonic element array 11, as shown in FIG. 8, even when the foremost edges of the three arrays are aligned, a comparison at the aligned position between the first ultrasonic element 111 and the second ultrasonic element 121 can still reveal their center-position relationship in the first direction: the center of the second ultrasonic element 121 (approximately at half of the second pitch Pt2) is offset relative to the center of the first ultrasonic element 111 (approximately at half of the first pitch Pt1) by an amount equal to the first predetermined distance T1 described in the first embodiment. In other words, even with aligned leading edges, the two second ultrasonic element arrays 12 remain offset from the first ultrasonic element array 11 in center alignment, so that the overall arrangement still constitutes a staggered configuration and achieves the technical effect of reducing sidelobes and improving image quality.

Because the second pitch Pt2 of the second ultrasonic element arrays 12 increases, the equivalent length of the staggered ultrasonic transducer M in the long-axis direction (i.e., the Y-axis direction in FIG. 1) increases accordingly. Therefore, compared with the ultrasonic generation module 1A of the first embodiment (FIG. 2), the ultrasonic generation module 1B of the second embodiment is configured with fewer ultrasonic elements. Nevertheless, by adjusting the pitch, it can still achieve a focusing effect comparable to that of module 1A. In other words, by increasing the pitch and properly arranging the elements, it is possible to reduce the number of ultrasonic elements while maintaining the required imaging resolution and focusing performance, thereby further simplifying the transducer design and lowering manufacturing costs.

In addition, the increased equivalent length of the staggered ultrasonic transducer M in the long-axis direction implies an expanded scanning coverage. Thus, during ultrasound scanning, users can complete imaging over a larger area in one scan, without having to frequently move the transducer to cover the entire area to be tested, which helps improve operational efficiency and imaging continuity. Moreover, by enlarging the scanning area of a single transducer, the frequency of switching among transducers of different lengths in clinical applications can be reduced, thereby avoiding positioning errors and re-registration steps during transducer changes and effectively improving examination accuracy and convenience.

### Third Embodiment

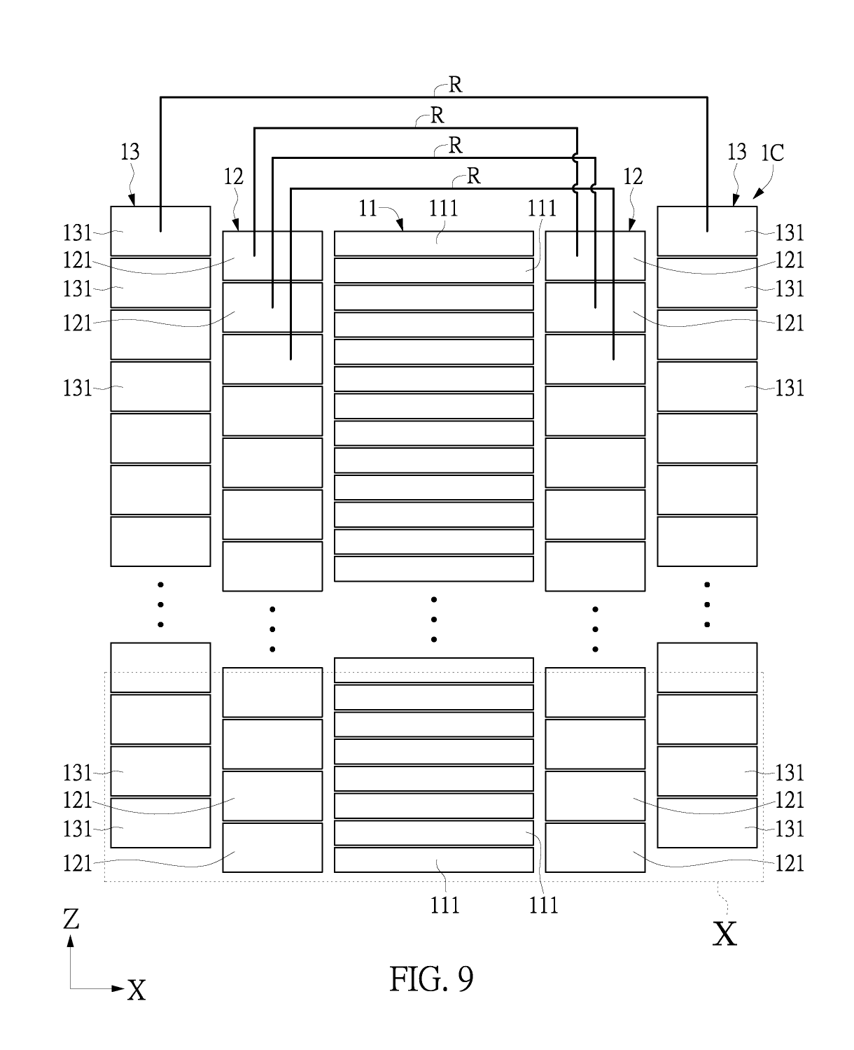

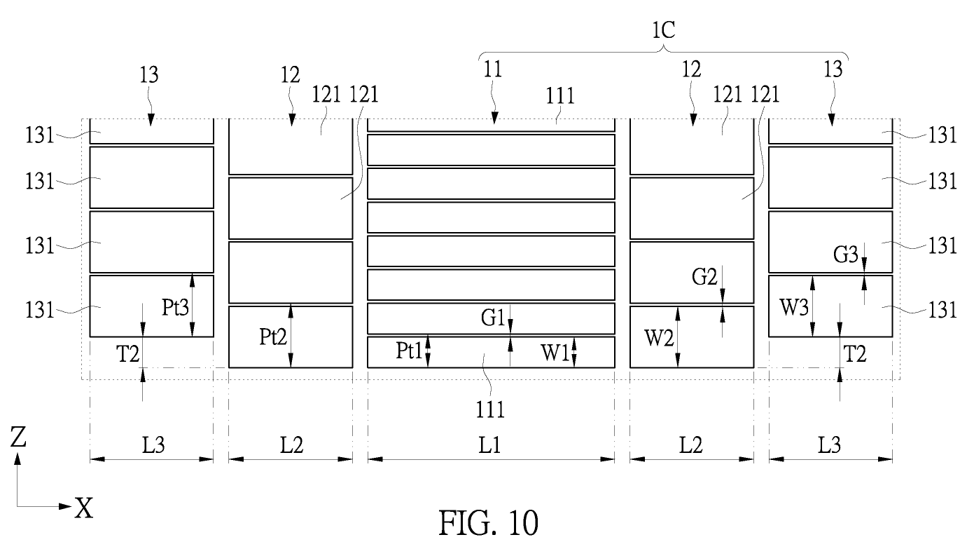

Reference is made to FIGS. 9 and 10. FIG. 9 is a schematic cross-sectional view of an ultrasonic generation module according to a third embodiment of the present disclosure, and FIG. 10 is a schematic enlarged view of part X of FIG. 9. In the third embodiment, the staggered ultrasonic transducer M includes an ultrasonic generation module 1C. The ultrasonic generation module 1C includes a first ultrasonic element array 11 and two second ultrasonic element arrays 12, and the structural design of the first and second ultrasonic element arrays is the same as that of the second embodiment. In addition, the ultrasonic generation module 1C further includes two third ultrasonic element arrays 13.

The two third ultrasonic element arrays 13 are aligned with each other and are parallel to the first ultrasonic element array 11 and the two second ultrasonic element arrays 12. The first ultrasonic element array 11 and the two second ultrasonic element arrays 12 are disposed between the two third ultrasonic element arrays 13. Each of the third ultrasonic element arrays 13 includes a plurality of third ultrasonic elements 131, which are arranged along the first direction with a third pitch Pt3.

In each of the third ultrasonic element arrays 13, any two adjacent third ultrasonic elements 131 are spaced apart by a third gap G3. Similar to the first gap G1 of the first ultrasonic element array 11 and the second gap G2 of the second ultrasonic element arrays 12, the third gap G3 can be formed by dicing or a photomask exposure process. The first gap G1, the second gap G2, and the third gap G3 are each less than 25% of the first pitch Pt1. In the embodiments of the present disclosure, the first gap G1, the second gap G2, and the third gap G3 are equal, but the present disclosure is not limited thereto.

In addition, the second pitch Pt2 of each of the second ultrasonic element arrays 12 is twice the distance of the first pitch Pt1 of the first ultrasonic element array 11, and the third pitch Pt3 of each of the third ultrasonic element arrays 13 is twice the distance of the first pitch Pt1. Furthermore, the first length L1 of each of the first ultrasonic elements 111 is greater than a third length L3 of each of the third ultrasonic elements 131, but the present disclosure is not limited thereto. In other embodiments, the first length L1 can be equal or less than the third length L3. In the first direction (i.e., the Z-axis direction), the two third ultrasonic element arrays 13 are offset relative to the first ultrasonic element array 11 by a second predetermined distance T2. The second predetermined distance T2 is equal to the first pitch Pt1.

### Fourth Embodiment

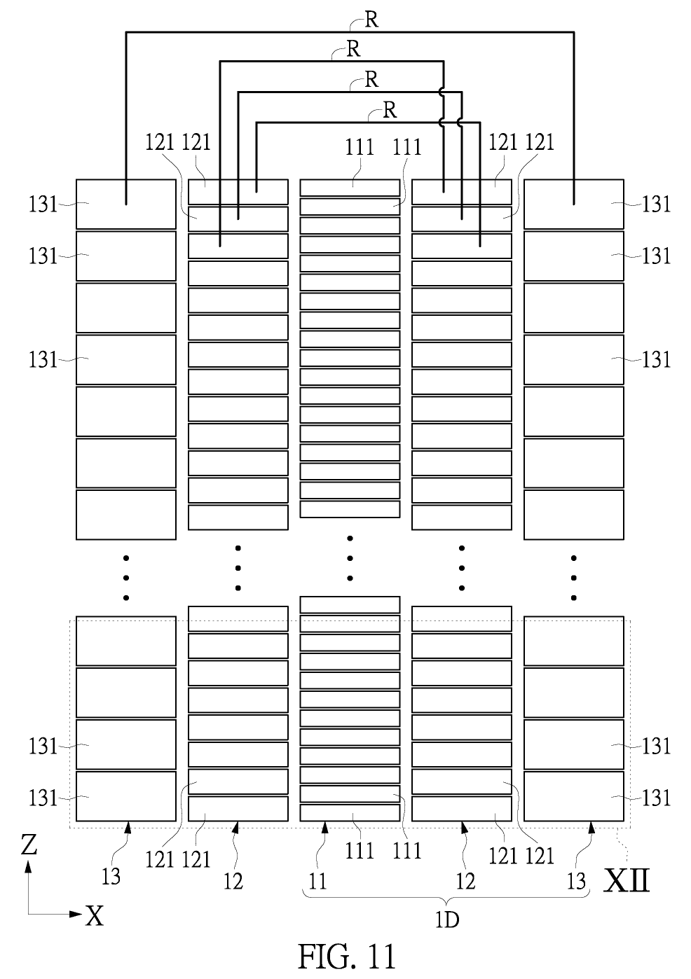

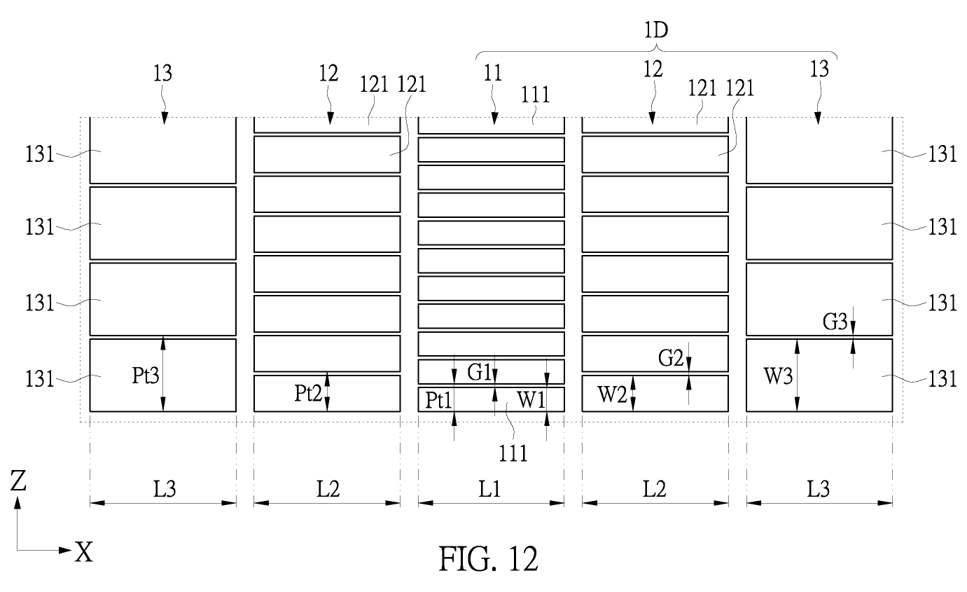

Reference is made to FIGS. 11 and 12. FIG. 11 is a schematic cross-sectional view of an ultrasonic generation module according to a fourth embodiment of the present disclosure, and FIG. 12 is a schematic enlarged view of part XII of FIG. 11. The ultrasonic generation module 1D of the fourth embodiment is also applicable to the staggered ultrasonic transducer M shown in FIG. 1. The ultrasonic generation module 1D of the fourth embodiment includes a first ultrasonic element array 11, two second ultrasonic element arrays 12, and two third ultrasonic element arrays 13.

The two third ultrasonic element arrays 13 are aligned with each other and are parallel to the first ultrasonic element array 11 and the two second ultrasonic element arrays 12. The first ultrasonic element array 11 and the two second ultrasonic element arrays 12 are disposed between the two third ultrasonic element arrays 13. Each of the third ultrasonic element arrays 13 includes a plurality of third ultrasonic elements 131 arranged along the first direction with the third pitch Pt3. In addition, the first gap G1 of the first ultrasonic element array 11, the second gap G2 of each of the second ultrasonic element arrays 12, and the third gap G3 of each of the third ultrasonic element arrays 13 are each less than 25% of the first pitch Pt1. In the embodiments of the present disclosure, the first gap G1, the second gap G2, and the third gap G3 are equal, but the present disclosure is not limited thereto.

In the fourth embodiment, the second pitch Pt2 is 1.5 times the first pitch Pt1, and the third pitch Pt3 is three times the first pitch Pt1. Therefore, as shown in FIG. 12, although the leading edges of the two third ultrasonic element arrays 13 and the two second ultrasonic element arrays 12 are aligned with the leading edge of the first ultrasonic element array 11, due to the different pitch designs of the respective arrays, a comparison at the aligned position among the first ultrasonic element 111, the second ultrasonic element 121, and the third ultrasonic element 131 reveals their center-position relationship in the first direction: the center of the second ultrasonic element 121 (approximately at half of the second pitch Pt2) is offset relative to the center of the first ultrasonic element 111 (approximately at half of the first pitch Pt1) by an amount equal to the first predetermined distance T1 described in the first embodiment; the center of the third ultrasonic element 131 (approximately at half of the third pitch Pt3) is offset relative to the center of the first ultrasonic element 111 by another amount equal to the second predetermined distance T2 described in the third embodiment. In other words, even with aligned leading edges, the two third ultrasonic element arrays 13 and the two second ultrasonic element arrays 12 remain offset from the first ultrasonic element array 11 in center alignment, so the overall arrangement still constitutes a staggered configuration and achieves the technical effect of reducing sidelobes and improving image quality.

In the short-axis direction (i.e., the X-axis direction, also known as the second direction) corresponding to the staggered ultrasonic transducer M, the first length L1 of the first ultrasonic element 111 is equal to about 20% to 40% of the total length of the ultrasonic generation module 1D in that direction. For example, within the total length of the ultrasonic generation module 1D along the second direction, the proportion of the first length L1 of the first ultrasonic element 111 is 20%, the proportion of the second length L2 of each of the second ultrasonic elements 121 is 20%, and the proportion of the third length L3 of each of the third ultrasonic elements 131 is 20%. This equal-ratio configuration provides structural balance and helps the transducer maintain consistent lateral resolution and energy distribution during imaging.

However, the specific ratio configuration is not limited in the present disclosure. In other embodiments, adjustments may be made according to imaging requirements and structural design. For example, in another embodiment, the first length L1 of the first ultrasonic element 111 can be increased to 40% of the total length, while the length of each of the second ultrasonic elements 121 and the length of each of the third ultrasonic elements 131 can each be 15% of the total length. By adjusting the proportions of the ultrasonic elements along the second direction, the focusing performance and imaging quality of the transducer can be optimized, and penetration capability and resolution performance for regions at different depths can be enhanced.

### Beneficial Effects of the Embodiments

In conclusion, in the staggered ultrasonic transducer M provided by the present disclosure, the ultrasonic element arrays within the ultrasonic generation modules 1A, 1B, 1C, and 1D are designed in a staggered configuration. Through the staggered design, the ultrasonic elements arranged along the second direction (i.e., the X-axis direction, also known as the short-axis direction) are non-collinear, thereby effectively reducing the equivalent width of the staggered ultrasonic transducer M in the short-axis direction. Accordingly, when the ultrasonic generation modules 1A, 1B, 1C, and 1D emit ultrasonic beams, sidelobe energy that may originally concentrate and overlap along a specific axial direction can be dispersed, reducing the accumulation effect of the sidelobe energy, effectively lowering sidelobe intensity in the near field, thereby suppressing artifact generation and optimizing imaging quality.

In addition, the staggered design increases the equivalent length of the staggered ultrasonic transducer M in the long-axis direction (the Y-axis direction), which expands the scanning coverage of the transducer. Thus, during ultrasound scanning, users can complete imaging over a larger area in one scan, without having to frequently move the transducer to cover the entire area to be tested, which helps improve operational efficiency and imaging continuity. Moreover, by enlarging the scanning area of a single transducer, the frequency of switching among transducers of different lengths in clinical applications can be reduced, thereby avoiding positioning errors and re-registration steps during transducer changes and effectively improving examination accuracy and convenience.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A staggered ultrasonic transducer, comprising:
an ultrasonic generation module, including:
a first ultrasonic element array including a plurality of first ultrasonic elements, the plurality of first ultrasonic elements being arranged along a first direction with a first pitch; and
two second ultrasonic element arrays aligned with each other and parallel to the first ultrasonic element array, the first ultrasonic element array being disposed between the two second ultrasonic element arrays, each of the second ultrasonic element arrays including a plurality of second ultrasonic elements, and the plurality of second ultrasonic elements being arranged along the first direction;
wherein, in the first direction, each of the two second ultrasonic element arrays is offset relative to the first ultrasonic element array by a first predetermined distance, and the first predetermined distance is equal to 1/3 to 3/4 of the first pitch.

2. The staggered ultrasonic transducer according to claim 1, wherein each of the first ultrasonic elements has a first length along a second direction, the first direction is perpendicular to the second direction, and the first length is equal to 40% to 70% of a total length of the ultrasonic generation module in the second direction.

3. The staggered ultrasonic transducer according to claim 1, wherein each of the first ultrasonic elements has a first length along a second direction, each of the second ultrasonic elements has a second length along the second direction, the first direction is perpendicular to the second direction, the first length is equal to 50% of a total length of the ultrasonic generation module in the second direction, and the second length is equal to 25% of the total length of the ultrasonic generation module in the second direction.

4. The staggered ultrasonic transducer according to claim 1, wherein each of the first ultrasonic elements has a first length along a second direction, each of the second ultrasonic elements has a second length along the second direction, the first direction is perpendicular to the second direction, the first length is equal to 70% of a total length of the ultrasonic generation module in the second direction, and the second length is equal to 15% of the total length of the ultrasonic generation module in the second direction.

5. The staggered ultrasonic transducer according to claim 1, wherein the plurality of second ultrasonic elements of each of the second ultrasonic element arrays are arranged along the first direction with a second pitch, and the second pitch is twice the first pitch.

6. The staggered ultrasonic transducer according to claim 5, wherein the ultrasonic generation module further includes two third ultrasonic element arrays aligned with each other and parallel to the first ultrasonic element array and the two second ultrasonic element arrays, the first ultrasonic element array and the two second ultrasonic element arrays are disposed between the two third ultrasonic element arrays, each of the third ultrasonic element arrays includes a plurality of third ultrasonic elements, and the plurality of third ultrasonic elements are arranged along the first direction with a third pitch.

7. The staggered ultrasonic transducer according to claim 6, wherein, in the first direction, each of the two third ultrasonic element arrays is offset relative to the first ultrasonic element array by a second predetermined distance, and the second predetermined distance is equal to the first pitch.

8. The staggered ultrasonic transducer according to claim 6, wherein the third pitch is twice the first pitch.

9. The staggered ultrasonic transducer according to claim 6, wherein the second pitch is 1.5 times the first pitch, and the third pitch is three times the first pitch.

10. The staggered ultrasonic transducer according to claim 6, wherein each of the first ultrasonic elements has a first length along a second direction, the first direction is perpendicular to the second direction, and the first length is equal to 20% to 40% of a total length of the ultrasonic generation module in the second direction.

11. The staggered ultrasonic transducer according to claim 6, wherein each of the first ultrasonic elements has a first length along a second direction, each of the second ultrasonic elements has a second length along the second direction, each of the third ultrasonic elements has a third length along the second direction, the first direction is perpendicular to the second direction, the first length is equal to 20% of a total length of the ultrasonic generation module in the second direction, the second length is equal to 20% of the total length of the ultrasonic generation module in the second direction, and the third length is equal to 20% of the total length of the ultrasonic generation module in the second direction.

12. The staggered ultrasonic transducer according to claim 6, wherein each of the first ultrasonic elements has a first length along a second direction, each of the second ultrasonic elements has a second length along the second direction, each of the third ultrasonic elements has a third length along the second direction, the first direction is perpendicular to the second direction, the first length is equal to 40% of a total length of the ultrasonic generation module in the second direction, the second length is equal to 15% of the total length of the ultrasonic generation module in the second direction, and the third length is equal to 15% of the total length of the ultrasonic generation module in the second direction.

13. The staggered ultrasonic transducer according to claim 6, wherein two adjacent first ultrasonic elements of the first ultrasonic element array are spaced apart by a first gap, two adjacent second ultrasonic elements of each of the second ultrasonic element arrays are spaced apart by a second gap, two adjacent third ultrasonic elements of each of the third ultrasonic element arrays are spaced apart by a third gap, and the first gap, the second gap, and the third gap are each less than 25% of the first pitch.

14. The staggered ultrasonic transducer according to claim 1, further comprising an acoustic lens layer disposed on one side of the ultrasonic generation module, wherein the acoustic lens layer has a first lens surface and two second lens surfaces, the first lens surface is disposed between the two second lens surfaces, the first lens surface corresponds to the first ultrasonic element array, and the two second lens surfaces correspond to the two second ultrasonic element arrays, respectively.

15. The staggered ultrasonic transducer according to claim 14, wherein a contour shape of the first lens surface is arc-shaped, and a contour shape of the second lens surface is jagged; and wherein the first lens surface has a first focal length, the two second lens surfaces each have a second focal length, and the second focal length is greater than the first focal length.

16. The staggered ultrasonic transducer according to claim 14, wherein any two of the second ultrasonic elements aligned with each other in the two second ultrasonic element arrays are electrically connected in series.
